(19) United States
(12) Patent Application Publication
(10) Pub. No.: US 2024/0120509 A1
(43) Pub. Date: Apr. 11, 2024

(54) BIPOLAR PLATE FOR A FUEL CELL STACK

(71) Applicant: CELLCENTRIC GMBH & CO. KG, Kirchheim/Teck-Nabern (DE)

(72) Inventor: Wayne DANG, Burnaby (CA)

(21) Appl. No.: 18/554,814

(22) PCT Filed: Apr. 19, 2022
(86) PCT No.: PCT/EP2022/060207

§ 371 Date: Oct. 11, 2023

(30) Foreign Application Priority Data
Apr. 21, 2021 (DE) 10 2021 203 965.0

(51) Int. Cl. H01M 8/0258; H01M 8/0213; H01M 8/0221; H01M 8/0226; H01M 8/0228; H01M 8/2483

(52) U.S. Cl. CPC H01M 8/0258; H01M 8/0213; H01M 8/0221; H01M 8/0226; H01M 8/0228; H01M 8/2483

(57) ABSTRACT

The invention relates to a bipolar plate (1) for a fuel cell stack having two layers (2, 3) which each have an anode-side or cathode-side flow area (9) on their surfaces facing away from one another, wherein aligned media inlet openings (4, 13, 15) and media outlet openings (5, 14, 16) are provided in the two layers (2, 3), wherein each of the media inlet and outlet openings (4, 5, 13, 14, 15, 16) are connected to channels (6) between the inner surfaces of the two layers (2, 3) facing toward one another, and wherein the channels (6) assigned to the anode side and the cathode side are each connected to the anode-side or cathode-side flow areas via openings (7) in the respective layer (2, 3). The bipolar plate according to the invention is characterized in that the material of the respective layer (2, 3) is reinforced in the sections (17) opposite to the openings (7) of the other layer (3, 2).

The invention relates to a bipolar plate for a fuel cell stack having two layers, according to the type defined in more detail in the preamble of claim 1.

Bipolar plates for fuel cells are known in principle from the prior art. They are used in the fuel cells on the one hand for electrically contacting the electrodes of the fuel cells and on the other hand for supplying and removing media to and from the fuel cells. In addition, they typically comprise a cooling medium flow field to also assume the cooling of the fuel cell stack.

A generic bipolar plate is known, for example, from WO 2008/061094 A1. In this case, two layers or halves are joined together to form the actual bipolar plate. The media are supplied to the plate via media inlet openings and media outlet openings. Channels are formed between the two layers in order to guide the media more or less into the interior of the bipolar plate. From there, the media pass through openings, which are also referred to as backfeed slots or backfeed channels, from the interior of the bipolar plate into the corresponding flow areas for the media on the cathode side and the anode side of the bipolar plate. The flow of the cooling medium typically continues to take place in the interior of the bipolar plate, so that the openings are formed only in the one half toward the anode-side flow area and in the other half toward the cathode-side flow area.

Comparable structures which also use this technology are also known from WO 03/083979 A2, WO 2015/145233 A1, U.S. Pat. No. 9,105,883 B2, and US 2007/0117001 A1.

Reference can also be made to U.S. Pat. No. 8,927,170 B2 for further prior art.

In practice, this structure has now proven itself in principle. In some situations, however, it has also turned out to be very prone to failure. For example, if ice forms in the area of the opening, the adjacent bipolar plate can be negatively affected or even destroyed, because the freezing water increases its volume accordingly and thus presses very strongly on the material of the half or layer of the bipolar plate adjacent to the opening. In the worst case, a crack forms here, which destroys the bipolar plate. In addition, tearing of the material of the bipolar plate can also occur in these areas in the event of particularly strong pressure differences in the mentioned areas if the pressure propagates through the openings and the opposite sides of the adjacent layers of the bipolar plate are negatively affected in case of extreme pressure events.

The object of the present invention is therefore to specify an improved bipolar plate.

According to the invention, this object is achieved by a bipolar plate having the features in claim 1. Advantageous embodiments and refinements result from the claims dependent thereon.

The bipolar plate according to the invention is constructed from two layers, comparable to the bipolar plates described in the prior art mentioned at the outset, with a connection of the flow areas to the interior of the bipolar plate via suitable openings. According to the invention, the material of the respective layer of the bipolar plate is reinforced in each of the sections opposite to the openings in the other layer. In practice, the inventor has found that the bipolar plates are adversely affected by cracks or even openings in practice almost always in the areas opposite to the openings. By reinforcing the material of the bipolar plate, in which the layer of the bipolar plate opposite to the opening is correspondingly reinforced in the area opposite to the opening, this can be efficiently remedied without the entire structure of the bipolar plate having to be changed or other adjustments having to be made.

The corresponding sections of the bipolar plate can be reinforced in various ways. A particularly simple and efficient solution provides for the reinforcement to be implemented by a greater material thickness. Other possibilities, for example the introduction of reinforcement materials, lacquers, resins, or the like that reinforce the layer structure, would also in principle be conceivable and possible.

According to a very advantageous refinement of the bipolar plate according to the invention, the preferred embodiment by reinforcement via a greater material thickness provides for the reinforcement to be implemented by a greater material thickness. This material thickness is greater than the material thickness between the deepest point of the flow area, which is typically formed by a depression in the surface of the respective layer. Flow distribution structures and/or flow guiding structures that project above the bottom of the depression are then arranged in this depression. The remaining residual thickness of the respective layer of the bipolar plate between the deepest point of the flow area and the opposite surface of the same layer represents the minimum material thickness of the respective layer. If this is now correspondingly reinforced in the areas opposite to the openings in the adjacent layer, an increase in the service life of the bipolar plate can be achieved easily and very efficiently. Since the area of the openings is relatively small in relation to the total area of the bipolar plate or its flow areas, it is already sufficient if small surface sections are correspondingly reinforced in order to achieve the advantages mentioned.

According to an extraordinarily favorable refinement of the idea, this can be achieved, for example, in that the greater material thickness is achieved by a section of the flow area having reduced depth. The remaining wall thickness of the flow area is therefore somewhat greater in the reinforced section, so that the depth and thus the flow cross section within the flow area is reduced in this small section. However, since the reinforced section is typically very small and is located in the edge area of the flow area, this has virtually no or at least not a very large effect on the flow itself.

The reinforced section having the smaller depth of the flow area can in principle be implemented independently within the flow area, for example by creating a kind of base around the flow distribution structures or flow guiding structures in this area. It is particularly advantageous, however, if the reinforced section is correspondingly connected to the edge of the flow area, since then a connection of the reinforced area to the edge areas of the flow area that is present at least on one side or, in the case of an arrangement in the corner also on two sides, can achieve even better reinforcement with an even more suitable dissipation of the forces.

An alternative thereto can also provide that the greater material thickness is implemented by shifting the flow area out of the reinforced section. In this variant, the entire flow area in the reinforced section is dispensed with, so that this is made somewhat smaller, and the full thickness of the layer opposite to the opening of the adjacent layer remains in the reinforced section.

A further embodiment can also provide that the greater material thickness results from a smaller depth of the channel or by dispensing with the channel in the layer having the reinforced section. The channel lying inside between the two layers of the bipolar plate is thus shifted more or less in the direction of the layer that has the opening, which automatically creates the reinforced section having greater material thickness in the area of the adjacent layer opposite to the respective opening.

The greater material thickness in the reinforced section can be 1.5 to 2.5 times, preferably 2 to 2.5 times the material thickness between the deepest point of the flow area in the layer and the opposite surface of the same layer. The residual material thickness of the respective layer is therefore multiplied by a factor of 1.75, for example, in order to create the correspondingly reinforced area. With the usual dimensions of bipolar plates and the depth of the flow areas, the depth of the flow area is reduced by half or a little more than half, which in principle impairs the flow, but due to the arrangement of the reinforced sections, which are very small in terms of surface area in relation to the area of the flow areas, typically at the edge of the flow areas, does not have an excessive influence on the even distribution of the flow and the flow of the media through the flow area of the bipolar plate.

Alternatively to such a reinforcement with a greater material thickness or in principle also additionally thereto, it can also be provided that reinforcement materials, for example fibers, woven fabrics, knitted fabrics, or the like are introduced into the reinforced sections. This is relatively easy to implement in production, in particular when the individual layers are produced from a plastic matrix filled with graphite or another carbon-containing material.

The flow area itself can preferably include a flow field and two distribution areas comprising the openings. According to an advantageous refinement, it can be provided that the flow field includes flow channels and the distribution areas include open flow distribution structures, in particular in the form of nubs. Especially with such a design of the flow areas, it is the case that the openings typically lie opposite to the distribution areas of the adjacent layer. These can be reinforced relatively easily by slightly increasing the material thickness here, so that, for example, the nubs of the distribution areas are no longer arranged on the bottom of the flow area but on a kind of base in the reinforced section. The flow is only minimally influenced as a result, the installation of the bipolar plate can be implemented efficiently and achieves high mechanical reliability and durability.

In principle, this applies to all types of bipolar plates. However, according to a particularly preferred embodiment of the bipolar plate according to the invention, it is provided that the two layers are each formed from a carbon-containing material in a plastic matrix. The structure in which, for example, graphite as a filler is hardened in a suitable matrix is often also referred to as a graphite bipolar plate or carbon bipolar plate.

Further advantageous embodiments of the bipolar plate according to the invention result from the exemplary embodiments, which are described in more detail hereinafter with reference to the figures.

In the figures:

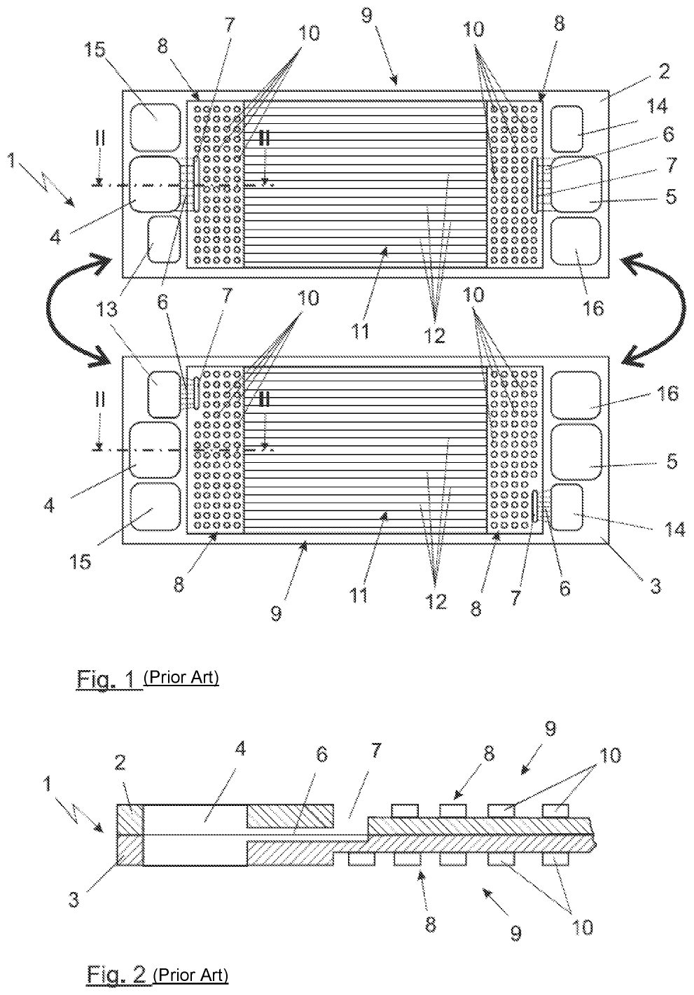

FIG. 1 shows a bipolar plate according to the prior art having its two opposing surfaces before assembling its layers;

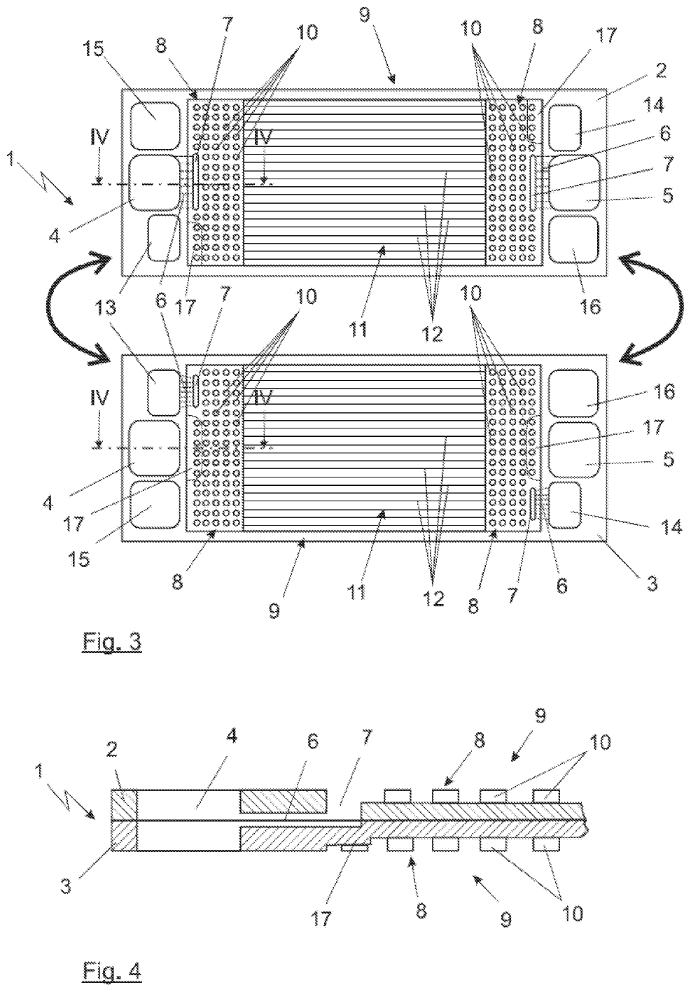

FIG. 2 shows a schematic sectional view along line II-II after assembling the layers according to FIG. 3;

FIG. 3 shows a bipolar plate having its two opposing surfaces before assembling its layers;

FIG. 4 shows a schematic sectional view along line IV-IV after assembling the layers according to FIG. 1;

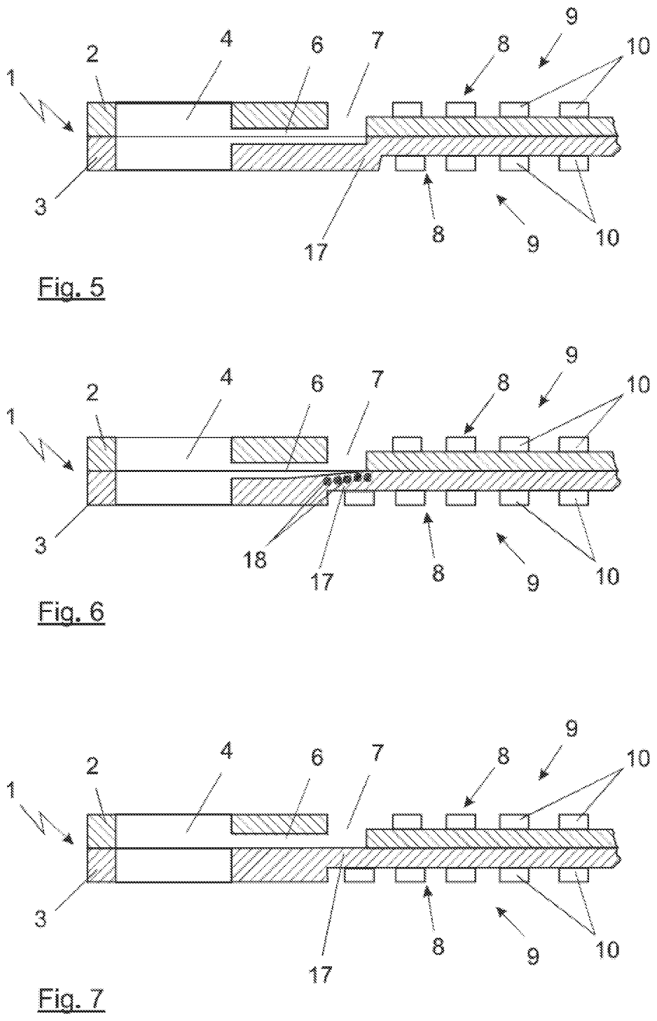

FIG. 5 shows an alternative embodiment of the bipolar plate according to the invention in a representation analogous to that in FIG. 4;

FIG. 6 shows a further alternative embodiment of the bipolar plate according to the invention in a representation analogous to that in FIG. 4;

FIG. 7 shows still a further alternative embodiment of the bipolar plate according to the invention in a representation analogous to that in FIG. 4.

In the representation of FIG. 1, the top view of two layers 2, 3, which are still separate here, can be seen, which are then assembled to form the bipolar plate 1 according to the curved arrows. The upper layer 2 shows the cathode side, the lower layer 3 the anode side of the later bipolar plate 1. A flow field for a cooling medium, which is not shown in detail here, but is known in principle, is arranged on the respective rear sides of the two layers 2, 3 of the bipolar plate 1. The anode-side layer 2 now has a media inlet opening 4 and a media outlet opening 5. These are aligned in the two layers 2, 3 and aligned with other bipolar plates 1 stacked later to form the fuel cell stack, which is not shown here. Between the two layers 2, 3, thus on the rear side here according to the representation in FIG. 1, this media inlet opening 4 and the media outlet opening 5 are each connected via channels designated by 6 to an opening designated by 7. This opening 7 connects the channels 6 lying on the rear side of the layer 2 in the illustration of FIG. 1 and thus the media inlet opening 4 or the media outlet opening 5 to a distribution area 8 for the flow, which is arranged adjacent to the media inlet opening 4. In the distribution area 8 the flow is distributed as evenly as possible over the cross section of a flow area denoted in its entirety by 9 and correspondingly collected adjacent to the media outlet opening 5. For this purpose, open structures 10 that do not block the flow and are not conductive, which are designed here, for example, in the form of nubs, are arranged in the respective distribution areas 8. Between the distribution areas 8 there is a so-called flow field 11 as the largest part of the flow area 9 in terms of area, in which flow guiding structures, such as ribs 12, uniformly guide the flow along the gas diffusion layer of a membrane electrode arrangement later placed on the cathode-side layer 2 of the bipolar plate 1.

The structure of the anode-side layer 3 is essentially analogous, with the difference that the media inlet opening 13 for the hydrogen is located at an angle opposite to the corresponding media outlet opening 14 for the anode waste gas. Otherwise, the constructions with regard to the respective flow area 9 for the cathode side on the one hand and the anode side on the other hand are comparable and are each provided with the same reference symbols.

A cooling medium is fed in and removed again via the media inlet and outlet openings 15, 16 designated by 15 and 16 in both layers 2, 3, as is known in principle from the prior art. The routing of the cooling medium is irrelevant for the invention shown here, so that it does not have to be discussed further.

The principle of the internal channels 6 and the opening 7 is shown again in the representation of FIG. 2 on the basis of the schematic sectional representation along line II-II in the two layers 2, 3 of FIG. 1. The layers 2, 3 are marked with different hatching and are connected to each other. The media inlet opening 4 is arranged in alignment through both layers. It opens laterally into the channel 6, which is typically formed in each of the two layers for a part of its cross section. The opening 7 then connects the flow area 9 or its distribution area 8 having its nubs 10 on the cathode side to that of the media inlet opening 4, so that the air or oxygen can reach the distribution area 8 on this path and from there in a manner known per se into the flow field 11. On the other layer 3 in the opposite area, as can be seen from the illustration in FIG. 1, the local anode-side distribution area 8 having its nubs 10 is arranged.

The improved embodiment of the bipolar plate 1 is now shown in the representation of FIG. 3. In order to prevent mechanical impairment of the layers 2, 3 in the sections opposite to the openings 7 in the other layer, in these areas is, which are marked with 17 in the illustration in FIG. 3, which is otherwise to be understood analogously to the illustration in FIG. 1. These reinforced sections 17 are therefore opposite to the respective opening 7 of the respective other layer 3, 2, so that in the cathode-side layer 2, the reinforced sections 17 are arranged at the diagonally opposite corners, here bottom left and top right, and accordingly on the cathode-side layer 3 adjacent to the respective media inlet openings 4 or media outlet openings 5 for the cathode-side medium. The reinforced areas 17 are preferably connected to the edge of the flow area 9, in this case the respective distribution areas 8, in order to ensure a structure that is as stable as possible.

Analogously to the illustration in FIG. 2, with the structure of the bipolar plate 1 according to the prior art, a corresponding schematic sectional illustration along line IV-IV in FIG. 3 is also shown in FIG. 4. The structure corresponds insofar to the structure described in connection with FIG. 2. In contrast to the illustration in FIG. 2, only the reinforced area 17 is additionally present here. In the exemplary embodiment shown here, for this purpose the material of the cathode-side layer 3 opposite to the opening 7 of the anode-side layer 2 is reinforced so that the free depth of the flow area next to the nubs 10 opposite to the opening 7 is correspondingly reduced. As a result, sufficient reinforcement of the bipolar plate 1 in the reinforced section 17 is achieved by a greater material thickness. In particular, this can be planned directly during the production of the layer 3, i.e., in particular in a mold in which a carbon-containing material is molded in a plastic matrix and hardened to form the layer 3.

Further possibilities are described in each of the following figures, likewise analogously to the representation in FIG. 4. There, too, the material thickness is increased accordingly by the structural design. Alternatively thereto, it would also be conceivable to carry out this reinforcement accordingly by introducing paints, resins, intermediate layers, and inserting fiber materials during the production of the corresponding layer 2, 3 of the bipolar plate 1.

In the representation of FIG. 5, the anode-side flow area 9 is more or less reduced in the reinforced section 17, so that the material thickness is increased to the material thickness of the adjacent areas of the layer 3. Alternatively, it would also be possible, and this can in principle also be done in addition to the two described embodiment variants, to reduce the material thickness in the area of the channel 6 accordingly, which is indicated schematically in FIG. 6, in order to create the reinforced area 17.

Reinforcing fibers 18 are additionally indicated solely by way of example in the representation of FIG. 6, which could be introduced, for example, as carbon fibers, Kevlar fibers, glass fibers, or the like into the reinforced section 17.

Another possibility, recognizable in FIG. 7, for reinforcing the section 17 could also provide that the entire channel 6 is only arranged in the one point of the bipolar plate 1 shown here, i.e., in the cathode-side layer 2, so that, unlike in the prior art, the complete material thickness in the bottom area of the flow area 9 of the layer 3 opposite to the opening 7 in the layer 2 is retained.

What is claimed is:

1. A bipolar plate for a fuel cell stack having two layers which each have an anode-side or cathode-side flow area on their surfaces facing away from one another, wherein aligned media inlet openings and media outlet openings are provided in the two layers, wherein each of the media inlet and outlet openings are connected to channels in at least one of the inner surfaces of the two layer, and wherein the channels assigned to the anode side and the cathode side are each connected to the anode-side or cathode-side flow areas via openings in the respective layer,
wherein the material of the respective layer is reinforced in the sections opposite to the openings of the other layer,
wherein the flow area is formed by a depression in the surface of the respective layer, which has flow distribution and/or flow guiding structures projecting above the bottom of the depression, wherein the reinforced sections have a greater material thickness than the material thickness between the deepest point of the flow area in the respective layer and the opposite surface of the same layer,
wherein the greater material thickness is achieved by a section of the flow area having a reduced depth.

2. The bipolar plate as claimed in claim 1,
wherein
the reinforced section having reduced depth is connected to the edge of the flow area.

3. The bipolar plate as claimed in claim 1,
wherein
in the reinforced section no part of the flow area is formed.

4. The bipolar plate as claimed in claim 1,
wherein
the greater material thickness of the reinforced section is implemented by a smaller depth of the channel or by dispensing with the channel in the layer having the reinforced section.

5. The bipolar plate as claimed in claim 1,
wherein
the greater material thickness in the reinforced section is 1.5 to 2.5 times, preferably 2 to 2.5 times the material thickness between the deepest point of the flow area in the respective layer and the opposite surface of the same layer.

6. (canceled)

7. The bipolar plate as claimed in claim 1,
wherein
the flow area includes a flow field and two distribution areas comprising the openings, wherein the flow field includes flow guiding structures, in particular in the form of ribs, and the distribution areas include open flow distribution structures, in particular in the form of nubs.

8. The bipolar plate as claimed in claim 1,
wherein
the two layers are each formed from a plastic matrix filled with a carbon-containing material.

9. The bipolar plate as claimed in claim 7,
wherein
the reinforcement of the material in the reinforced section is implemented by applying or introducing a further material.

10. The bipolar plate as claimed in claim 2,
wherein
in the reinforced section no part of the flow area is formed.

11. The bipolar plate as claimed in claim 2,
wherein
the greater material thickness of the reinforced section is implemented by a smaller depth of the channel or by dispensing with the channel in the layer having the reinforced section.

12. The bipolar plate as claimed in claim 3,
wherein
the greater material thickness of the reinforced section is implemented by a smaller depth of the channel or by dispensing with the channel in the layer having the reinforced section.

13. The bipolar plate as claimed in claim 2,
wherein
the greater material thickness in the reinforced section is 1.5 to 2.5 times, preferably 2 to 2.5 times the material thickness between the deepest point of the flow area in the respective layer and the opposite surface of the same layer.

14. The bipolar plate as claimed in claim 3,
wherein
the greater material thickness in the reinforced section is 1.5 to 2.5 times, preferably 2 to 2.5 times the material thickness between the deepest point of the flow area in the respective layer and the opposite surface of the same layer.

15. The bipolar plate as claimed in claim 2,
wherein
the flow area includes a flow field and two distribution areas comprising the openings, wherein the flow field includes flow guiding structures, in particular in the form of ribs, and the distribution areas include open flow distribution structures, in particular in the form of nubs.

16. The bipolar plate as claimed in claim 3,
wherein
the flow area includes a flow field and two distribution areas comprising the openings, wherein the flow field includes flow guiding structures, in particular in the form of ribs, and the distribution areas include open flow distribution structures, in particular in the form of nubs.

17. The bipolar plate as claimed in claim 2,
wherein
the two layers are each formed from a plastic matrix filled with a carbon-containing material.

18. The bipolar plate as claimed in claim 3,
wherein
the two layers are each formed from a plastic matrix filled with a carbon-containing material.

19. The bipolar plate as claimed in claim 1,
wherein
the reinforcement of the material in the reinforced section is implemented by applying or introducing a further material.

20. The bipolar plate as claimed in claim 2,
wherein
the reinforcement of the material in the reinforced section is implemented by applying or introducing a further material.
